(19) United States
(12) Patent Application Publication
(10) Pub. No.: US 2019/0010889 A1
(43) Pub. Date: Jan. 10, 2019

(54) OPTIMIZATION OF CURRENT INJECTION PROFILE FOR SOLENOID INJECTORS

(71) Applicant: GM Global Technology Operations LLC, Detroit, MI (US)

(72) Inventors: Umberto Ferrara, Torino (IT); Luca Chiapusso, Torino (IT); Marco Borri, Torino (IT)

(21) Appl. No.: 15/644,014

(22) Filed: Jul. 7, 2017

(51) Int. Cl. F02D 41/24; F02M 51/06

(52) U.S. Cl. CPC F02D 41/2467; F02M 51/061

(57) ABSTRACT

Technical solutions are described for optimizing current injection profiles used for solenoid injectors, such as during fuel injection. An example fuel injector system includes a solenoid injector and a controller that receives a request for energizing the solenoid for an energizing time. The controller, in response to the requested energizing time exceeding a predetermined threshold, holds an electrical current applied to the solenoid injector at a predetermined minimum holding value for a holding phase. Further, the controller in response to the requested energizing time being less than the predetermined threshold, applies a predetermined peak-current value to the solenoid injector.

### INTRODUCTION

The present disclosure relates to fuel injection in internal combustion engines, and more specifically to a method for driving a solenoid-actuated fuel injector.

Conventional solenoid fuel injectors are provided with solenoid actuators and comprise a valve housing with current coil and electrical connections, a valve seat with a nozzle and a movable valve. When such an injector is energized (e.g., a current is sent to the solenoid actuator), the coil generates a magnetic field which lifts the valve off of its seat to allow fuel to flow through the injector and to escape out of the nozzle towards the combustion chamber of the associated cylinder. When the injector is de-energized (e.g., the current is no longer sent to the solenoid actuator), the valve is engaged with the valve seat.

In internal combustion engines utilizing solenoid activated fuel injectors for direct injection into combustion chambers, physical characteristics of the injector solenoid coil are often generally compensated by varying the injector current over the duration of a fuel pulse according to a predetermined injector current profile. One such physical characteristic is the inductive nature of the injector solenoid coil; and a typical such profile may provide an initial rise to a peak current level, in order to open the injector valve as rapidly as possible, followed by one or more periods of maintenance current at lower current levels.

Accordingly, it is desirable to control the use of different injector current profiles to optimize fuel pulses to produce different combustion characteristics.

### SUMMARY

Technical solutions are described for optimizing current injection profiles used for solenoid injectors, such as during fuel injection. One or more embodiments describe a fuel injector system that includes a solenoid injector and a controller that receives a request for energizing the solenoid for an energizing time. The controller, in response to the requested energizing time exceeding a predetermined threshold, holds an electrical current applied to the solenoid injector at a predetermined minimum holding value for a holding phase. Further, the controller in response to the requested energizing time being less than the predetermined threshold, applies a predetermined peak-current value to the solenoid injector.

Further, in response to the requested energizing time exceeding the predetermined threshold the controller applies to the solenoid injector the electrical current at the predetermined peak-current value prior to the holding phase. The holding phase has a predetermined duration. In one or more examples, in response to the requested energizing time being less than the predetermined threshold, the controller skips the holding phase.

Further, the solenoid injector injects an amount of fuel corresponding to the electrical current by opening a fuel injection value based on the electrical current.

In one or more examples, in response to the requested energizing time being less than the predetermined threshold, the controller sets a current shape flag to a first value that is indicative of using a first current pulse according to a first current profile. Further, in response to the requested energizing time exceeding the predetermined threshold, the controller sets the current shape flag to a second value that is indicative of using a second current pulse according to a second current profile.

In other exemplary embodiments a computer-implemented method for controlling fuel injection includes receiving a requested energizing time for a fuel injector solenoid, and in response to the requested energizing time exceeding a predetermined threshold, holding an electrical current applied to the fuel injector solenoid at a predetermined minimum holding value for a holding phase. Further, the method includes in response to the requested energizing time being less than the predetermined threshold, applying a predetermined peak-current value to the fuel injector solenoid.

In one or more examples, the holding phase has a predetermined duration. The method further includes, in response to the requested energizing time exceeding the predetermined threshold, applying to the fuel injector solenoid the electrical current at the predetermined peak-current value prior to the holding phase.

In one or more examples, in response to the requested energizing time being less than the predetermined threshold, the controller skips the holding phase. A solenoid injector injects an amount of fuel corresponding to the electrical current by opening a fuel injection value based on the electrical current.

In one or more examples, the method further includes in response to the requested energizing time being less than the predetermined threshold, setting a current shape flag to a first value that is indicative of using a first current pulse according to a first current profile. Further, in response to the requested energizing time exceeding the predetermined threshold, the current shape flag is set to a second value that is indicative of using a second current pulse according to a second current profile.

In yet other exemplary embodiments a computer program product including a non-transitory computer readable storage medium having computer executable instructions stored thereon, the computer executable instructions when executed by a processing circuit, cause the processing circuit to receive a requested energizing time for a fuel injector solenoid, and in response to the requested energizing time exceeding a predetermined threshold, hold an electrical current applied to the fuel injector solenoid at a predetermined minimum holding value for a holding phase. Further, in response to the requested energizing time being less than the predetermined threshold, apply a predetermined peak-current value to the fuel injector solenoid.

In one or more examples, the computer executable instructions further cause the processing circuit to, in response to the requested energizing time exceeding the predetermined threshold, applying to the fuel injector solenoid the electrical current at the predetermined peak-current value prior to the holding phase. The holding phase has a predetermined duration.

Further, the computer executable instructions further causing the processing circuit to, in response to the requested energizing time being less than the predetermined threshold, skip the holding phase. Further yet, the computer executable instructions further cause the processing circuit to, in response to the requested energizing time being less than the predetermined threshold, set a current shape flag to a first value that is indicative of using a first current pulse according to a first current profile, and in response to the requested energizing time exceeding the predetermined threshold, set the current shape flag to a second value that is indicative of using a second current pulse according to a second current profile.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically illustrates a vehicle including an internal combustion engine according to one or more embodiments;

FIG. 2A illustrates an example current profile of a direct injector solenoid according to one or more embodiments;

FIG. 2B depicts another view of the current profile indicative of discrete phases of the current flowing to the solenoid during a single cycle of the solenoid valve according to one or more embodiments;

FIG. 3 depicts fuel flow characteristics with different current profiles according to one or more embodiments;

FIG. 4 illustrates a flow chart of an example method for optimizing current injection profile for solenoid injectors according to one or more embodiments;

FIG. 5 illustrates a comparison between shapes of current pulses applied below and above the predetermined energizing time threshold value according to one or more embodiments; and

FIG. 6 depicts an example graph that depicts current profiles for a range of pressure values according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory module that executes one or more software or firmware programs, a combinational logic circuit, and/or other suitable components that provide the described functionality.

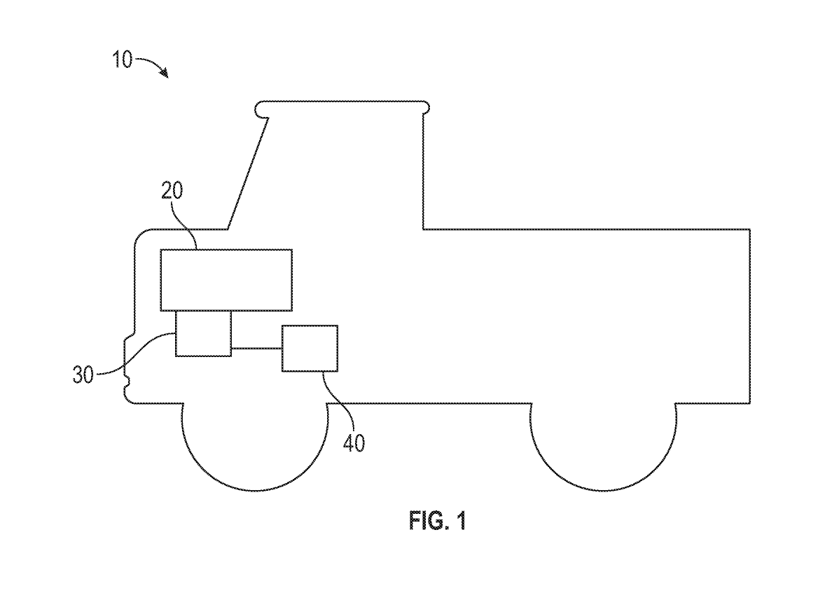

FIG. 1 schematically illustrates a vehicle 10 including an internal combustion engine 20 according to one or more embodiments. Operation of the engine 20 relies on periodic injection of fuel from a fuel injector solenoid 30 in a process referred to as direct injection. A controller 40, such as an engine controller, controls the injection timing, phasing and splitting and relies on accurate injector opening time response data in order to predict a physical fuel rail pressure in real time. The prediction is calculated according to various factors and techniques, for example a linear transfer function that has a good correlation with dependency on temperature. Typically, injectors utilize a combination of empirical data sets and predictive modeling to estimate the response time of the direct injector solenoid 30.

In one or more examples, the controller 40 manages engine fuel control and includes at least one digital microprocessor programmed to determine the fuel needs of the engine 20 through appropriate sensors for determining engine operating parameters such as crankshaft position, engine speed, engine load (intake airflow or throttle vacuum), etc., and to further determine and signal the timing and duration of injector activation in specified combustion chambers in the normal course of engine operation.

The illustrated engine controller 40 monitors and receives signals that indicate one or more events of the injector solenoid 30. For example, the controller 40 monitors opening times and injection times for the solenoid 30. Alternatively, or in addition, the engine controller 40 detects a current input to the direct injector solenoid 30 using one or more sensors and constructs a current profile of the direct injector solenoid 30. The current profile is a representation of the direct injector solenoid input current with respect to time.

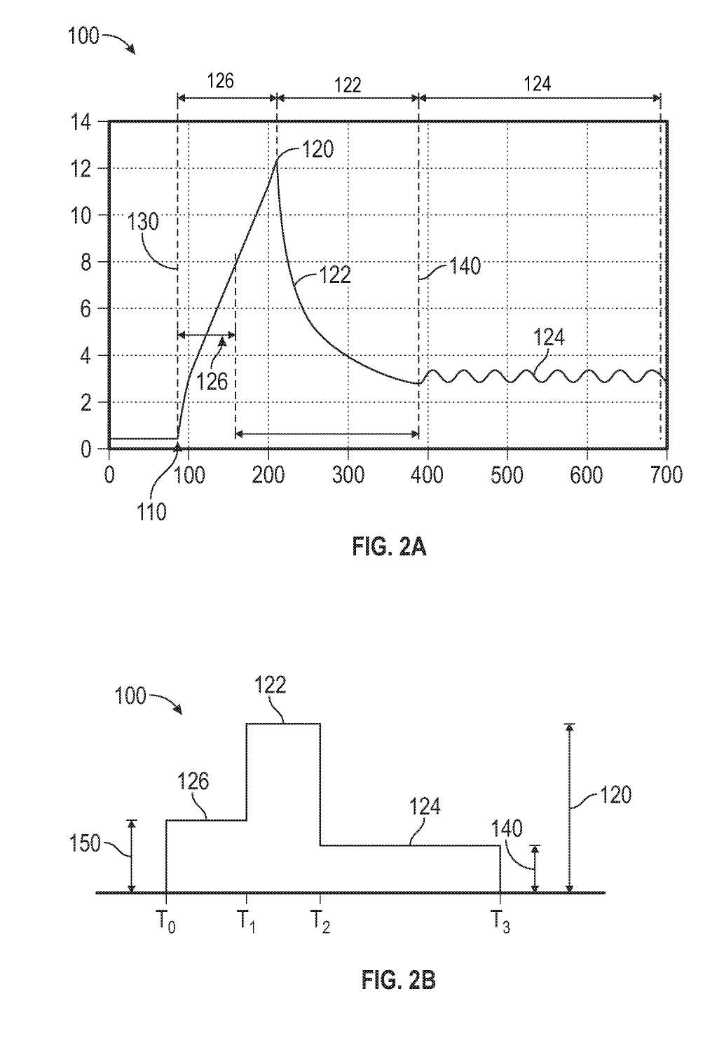

FIG. 2A illustrates an example current profile 100 of a direct injector solenoid 30 according to one or more embodiments. The controller 40 initially begins opening the direct injector solenoid 30 at a start of injection 110. Immediately following the start of injection 110, the current profile 100 rapidly rises until it reaches a peak 120. After the peak 120, the current profile 100 begins an exponential decline 122 until the reaching a current holding phase 124. In the holding phase 124 the current value is maintained at least at a predetermined threshold for a predetermined duration. The holding phase facilitates maintaining the already opened injector valve with a lower current (lower ECU energy consumption).

Typically, the solenoid fuel injector 30 is provided with solenoid actuators and comprise a valve housing with current coil and electrical connections, a valve seat with a nozzle and a movable valve. When such an injector is energized (e.g., a current is sent to the solenoid actuator), the coil generates a magnetic field which lifts the valve off of its seat to allow fuel to flow through the injector and to escape out of the nozzle towards the combustion chamber of the associated cylinder. When the injector is de-energized (e.g., the current is no longer sent to the solenoid actuator), the valve is pressed against the valve seat.

In order to cause a fuel injection to occur, a nominal start time for the injection and a nominal energizing time (ET) for the injector are predetermined by an electronic injection control unit, taking into account several parameters, such as for instance the amount of fuel to be injected, the engine speed, the engine power, the exhaust emissions. Referring to the graph of FIG. 2A, a voltage V having a predetermined nominal start value Vpull-in (“pull-in voltage”) is applied to the injector solenoid at the start of injection, energizing time (te) to cause in said solenoid the flow of an energizing current “I”, which very quickly increases from zero to a predetermined peak value (“pull-in current”) in a period of time, which is defined as the “pull-in period” or pull-in phase 126. The quick increase of the energizing current allows the coil to generate a sufficiently strong force to move an anchor within the injector, in order to permit the starting movement of the injector needle.

In one or more examples, to achieve a very fast movement of the anchor the solenoid current “I” must reach the peak value of the pull-in current as quickly as possible. For this reason initial voltage applied to the injector has a pull-in voltage value that is higher (for instance, between 50 V and 70 V) than the typical voltage value (for instance 12 V) available from the battery of the vehicle 10. The higher initial voltage value may be obtained with known booster circuits.

It is known in the art that a direct injector solenoid 30 is fully open at least a minimum time period after the start of injection. The minimum time period is illustrated as a delay window 130. Once the delay window 130 has passed, the controller 40 begins collecting data from the current profile 100, in order to precisely determine the injector opening time. The current data is collected from the end of the delay window 130 until the beginning of the current holding phase 124. This window of time is referred to as the data collection window 140.

Still referring to the graphs of FIG. 2A, at the end of the pull-in period, when the anchor is opened, there is usually no longer any need to maintain the current “I” at the peak value, since the fuel pressure itself is now capable to provide part of the force which is necessary to maintain the anchor opened. For this reason, the injector current is reduced, as shown in the graph of FIG. 2A, wherein the current “I” in the injector solenoid is reduced gradually, to subsequent lower levels. Until the current reaches a predetermined minimum hold current value, the solenoid 30 operates in the peak phase 122 for a peak period duration.

The above operation follows a peak and hold operation for the solenoid 30, where the drive circuit applies a higher current to the solenoid 30 while the solenoid 30 is in an open or a maximum air gap condition. Once the solenoid 30 has completed its travel to the closed or minimum air gap position, the current is reduced to the hold current level, which maintains the solenoid 30 in this position until the current is removed.

In one or more examples, the holding phase 124 may be associated with a specified minimum duration, which is referred to as a minimum holding phase, for example 0.1 microseconds, or any predetermined duration. Thus, typically the holding phase 124 has at least the minimum holding phase duration. For example, if the requested energizing time for the solenoid 30 is a long pulse, the controller 20 applies the minimum holding current for the holding phase 124 that is longer than the minimum holding phase duration. Further, in case the requested energizing time for the solenoid 30 is a short pulse, the controller 20 applies the minimum current value for the minimum holding phase duration, which is shorter in duration than the holding phase used for the long pulse. In other words, when the long pulse is requested, the holding phase 124 includes the minimum holding phase.

In one or more examples, the controller 40 includes a non-volatile memory dedicated for storage of a plurality of sets of injection current profile parameters. Each of these sets comprises numerical values defining such parameters as maximum and minimum switching current levels and time durations for injector current to produce a predetermined injector current profile during a single injector pulse. These sets of injection current profile parameters may be programmed into the memory of the controller 40 at any time when the engine is not operating. Once programmed into the memory, any of these stored sets of injection current profile parameters are available for use to control the injector current profile as supplied and directed by the controller 40.

The movement of the valve control element of the solenoid 30 has to be precisely controlled during the movement phase of the valve control element. A result of fluctuations in current supplied, an attraction time and/or an impact time of the armature or of the valve control element change, as a result of which it is disadvantageously difficult to precisely reproduce a closing process or the flight or movement phase of the solenoid 30. This is problematic in particular when there are precise requirements, for example when controlling the fuel injection in the internal combustion engine 20, since the physical start of the injection takes place in each case at a different point in time from the point in time as planned. This leads to changes in the quantity of fuel injected into the cylinder, which in turn leads to an undesired change in the engine torque and noise.

Particularly, in a small quantity area (SQA) of engine operation, where the fuel injected into the engine is lower than a predetermined threshold, maintaining linearity in the changes of the current and consequently the fuel being injected facilitates preventing undesired change in the engine torque, emissions, and fuel consumption. The small quantity area of engine operation varies from one engine to another, and is based on a configurable predetermined threshold, for example 3 cu. mm/stroke, or any other value. The technical solutions described herein address such technical challenges. In one or more examples, the technical solutions facilitate selection of appropriate injector current profile at run-time. The technical solutions thus provide an improved linearity of quantity curves, for example in the small quantity area with, and consequently, provide tolerance reduction for closed loop correction function. The technical solutions thereby improve, among other aspects, torque generation and fuel consumption of the engine 20, and in turn of the vehicle 10. Further, as will be described herein, the technical solutions further facilitate reduced electrical minimum energizing time value that results in no electrical limitation in driving hydraulic minimum energizing time.

In one or more examples, the technical solutions described herein facilitate different injector current profile management depending on energizing time (ET) length in order to increase linearity and smoothness of injector fuel flow characteristic in the small fuel quantity area. The technical solutions thus address the technical challenges posed by critical delivery of small fuel injection quantity at high rail pressure due to insufficient injector driving current. The technical solutions further facilitate a runtime change of current injection profile with increase in small fuel injection quantity accuracy in complex injection pattern, which in turn facilitates achieving noise and fuel consumption targets. Further yet, the technical solutions facilitate improved accuracy of fuel injected quantity for closed loop correction function (i.e. Small Quantity Adjustment strategy) in small quantity area needed to fulfill government/environmental agency requirements.

FIG. 2B depicts another view of the current profile 100 indicative of discrete phases of the current flowing to the solenoid 30 during a single cycle of the solenoid valve according to one or more embodiments. Typically, it is important to open and close the solenoid valve as quickly as possible, therefore, prior to actually opening the solenoid valve, current is supplied to the solenoid 30 to pre-charge the solenoid 30. During this pre-charge phase 126, the current supplied to the valve solenoid 30 is increased up to a current level, that is less than peak-value required to open the valve. The amplitude of the pre-charge phase 126 is established based upon the valve characteristics, and may be predetermined value. The duration, T1, of the pre-charge phase 126 is based upon the energizing speed of the valve solenoid 30. The length of time, T1, of the pre-charge phase 126 facilitates energizing the valve solenoid 30 to a point slightly below the level required to open the valve. If there is no initial current supplied to the valve solenoid 30 then the valve experiences a lag time while the valve solenoid 30 energizes to the point necessary to open the valve. By pre-charging the valve solenoid 30, this lag time is reduced or eliminated.

To open the valve, the current through the valve solenoid 30 is increased as quickly as possible until the valve is completely open. Maximizing the current into the valve solenoid 30 during the valve opening period decreases the valve opening time, making prediction of fuel volume delivered more accurate. This rapid increase in the current, or peak phase 122, has an amplitude that is significantly higher than is necessary to cause the valve to open. The amplitude of the peak phase 122 is established by the level of current necessary to open the valve, and by increasing the peak phase 122 current to a level that will maximize the opening speed of the valve. This high amplitude peak-current causes the valve to open rapidly, thereby reducing the amount of time for the valve to transition from closed to open. The time duration, T2−T1, of the peak phase 122 is just long enough to allow the valve to open completely and settle into its open position. This time will depend upon the physical characteristics of the valve, valve solenoid 30, voltage, and the peak-current amplitude of the peak phase 122.

Once the valve is opened, the high level current of the peak phase 122 is no longer necessary. During a hold phase 124 of the current profile, the current flowing through the valve solenoid 30 is lowered to an amplitude 140 that is just sufficient to hold the valve open. Due to friction, hysteresis, and other physical characteristics of the valve, the level of current necessary to hold the valve open is different than the level of current necessary to open the valve from a closed position. The amplitude 140 of the hold phase 124 that holds the valve open is less than the amplitude 150 of the current that opens the valve, although, depending upon the valve, the opposite could also be true. The amplitude 140 of the hold phase 124 is established based upon the physical characteristics of the current application. The time duration, T3−T2, of the hold phase 124 is established based upon how long fuel is to be injected through the valve. Fuel flows through the valve until the hold current is discontinued, and the valve closes again.

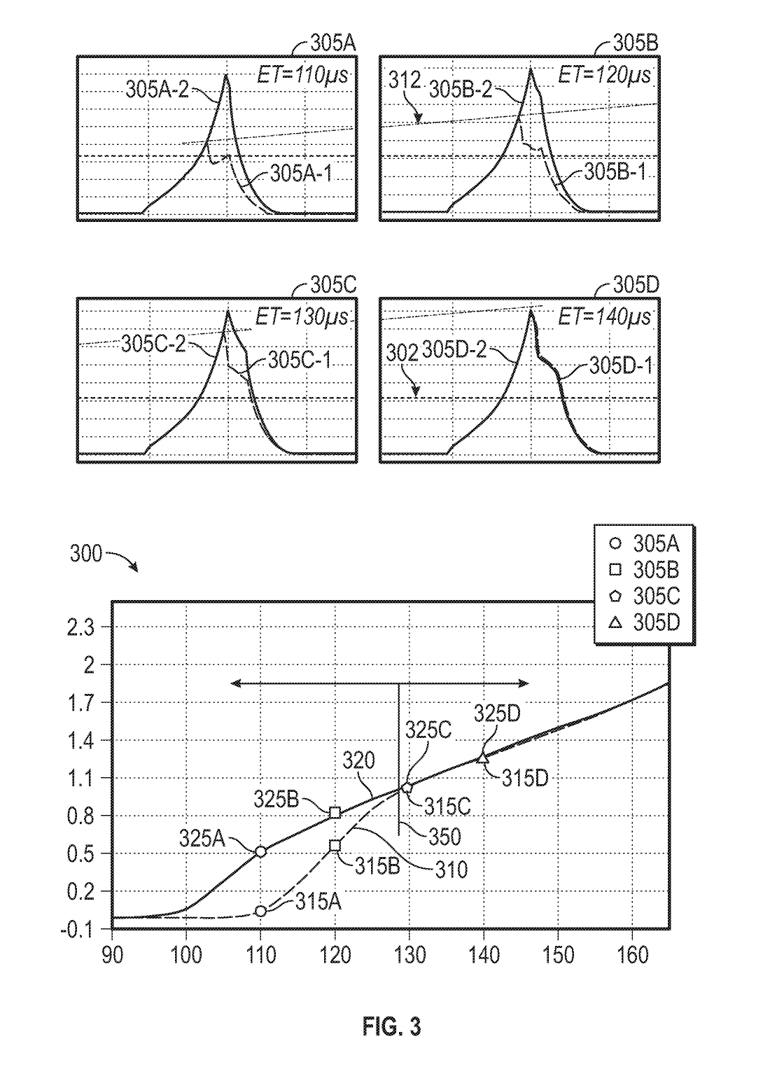

FIG. 3 depicts fuel flow characteristics with different current profiles according to one or more embodiments. The graph 300 depicts a plot of quantity of fuel injected (Y axis) into the engine 20 versus an energizing time of the solenoid 30 (X axis) using two different current profiles, a first current profile 310 and a second current profile 320. As can be seen, both current profiles result in substantially a similar amount of fuel being injected at energizing times above a specific energizing threshold value 350 that corresponds with the small quantity area, in this case 130 microseconds (μs). The energizing time threshold value 350 can be different in different examples, and is configurable. FIG. 3 further depicts shapes of currents applied at different energizing times as per the two current profiles 310 and 320. For example, shape 305A includes a plot 305A-1 of current values input by the first current profile 310 at energizing time 110 μs. Shape 305A further includes a plot 305A-2 of current values input by the second current profile 320 at the energizing time 110 μs.

Similarly, shape 305B includes a plot 305B-1 of current values input by the first current profile 310 at energizing time 120 μs and a plot 305B-2 of current values input by the second current profile 320 at the energizing time 120 μs. Further, shape 305C includes a plot 305C-1 of current values input by the first current profile 310 at energizing time 130 μs and a plot 305C-2 of current values input by the second current profile 320 at the energizing time 130 μs. Further yet, shape 305D includes a plot 305D-1 of current values input by the first current profile 310 at energizing time 140 μs and a plot 305D-2 of current values input by the second current profile 320 at the energizing time 140 μs. The graphs 305A-D further depict a minimum current value 302 that causes the solenoid 30 to open.

Referring to the graph 300, the plots for both, the first current profile 310 and the second current profile 320, are marked with examples to indicate the amount of fuel injected according to the current applied for the corresponding energizing times. For example, mark 315A depicts fuel injection at energizing time 110 μs according to the first current profile 310 based on the current applied according to the graph 305A-1. Further, mark 325A depicts fuel injection at energizing time 110 μs according to the second current profile 320 based on the current applied according to the graph 305A-2.

Similarly, mark 315B and mark 325B depict fuel injection at energizing time 120 μs according to the first current profile 310 and the second current profile 320, respectively, according to the graph 305B. Further, mark 315C and mark 325C depict fuel injection at energizing time 130 μs according to the first current profile 310 and the second current profile 320, respectively, according to the graph 305C. Further yet, mark 315D and mark 325D depict fuel injection at energizing time 120 μs according to the first current profile 310 and the second current profile 320, respectively, according to the graph 305D. As indicated earlier, and as can be seen in FIG. 3, the fuel injections are nearly identical for both current profiles at energizing times above the energizing time threshold 350.

As can be seen in FIG. 3 the fuel injection caused by the second current profile 320 is more linear in the small quantity area, which is below the predetermined energizing time threshold 305, compared to the fuel injections caused by the first current profile 310.

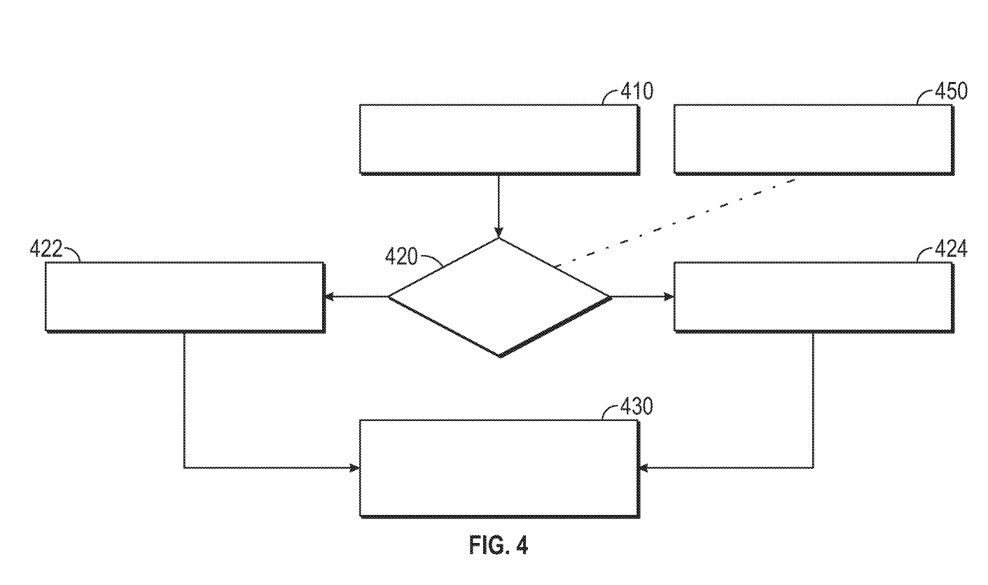

FIG. 4 illustrates a flow chart of an example method for optimizing current injection profile for solenoid injectors according to one or more embodiments. In one or more examples, the method is implemented by the controller 40. For example, one or more computer executable instructions are stored in non-transitory memory storage device that is accessible by the controller 40, which executes the instructions for performing the method. Alternatively, or in addition, the method may be implemented by one or more hardware components such as electronic circuits like application specific integrated circuits (ASIC), field programmable gate array (FPGA), and so on.

Referring to FIG. 4, the controller 40 receives a request/command for energizing the solenoid for a specific energizing time, as shown at 410. The controller 40 determines if the requested energizing time is above the predetermined energizing time threshold value 350, as shown at 420.

If the energizing time is above (or equal to) the predetermined energizing time threshold value 350, the controller 40 sets a current shape flag to a first value that indicates using configuration from the first current profile 310, as shown at 424. For example, the shape flag is set to NO CHANGE, which is just one example, and in other implementations, the flag value may be set to any other value indicative of the first current profile 310. Using the configuration from the first current profile 310 includes applying current to the solenoid injector 30 as specified by the first current profile 310, as shown at 430.

In one or more examples, the predetermined energizing time threshold value 350 is configurable, as shown at 450. For example, the predetermined energizing time threshold value 350 may be based on boost voltage that is applied to the solenoid to cause the pull-in current. For example, the predetermined energizing time threshold value 350 may be set to 130 μs, 140 μs, or any other value. Depending on the predetermined energizing time threshold value 350, the controller 40 changes the current profile being applied to the solenoid 30 dynamically, at runtime. In other words, the controller 40 uses specific injector current profile management that switches from one injector current profile waveform to another depending on the length of each requested injection pulse.

In one or more examples, the calibrating the predetermined energizing time threshold value 350 includes specifying the value for the threshold 350 itself and further providing current shapes to be applied when the requested energizing time is below and/or above the threshold. In one or more examples, the calibration is performed when the engine 20 and/or the vehicle 10 is manufactured. Alternatively, or in addition, the calibration may be performed when the engine 20 and/or the vehicle 10 is being serviced.

If the energizing time is below the predetermined energizing time threshold value 350, the controller 40 sets a current shape flag to a second value that indicates using configuration from the second current profile 320, as shown at 422. For example, the shape flag is set to MIN HOLD-PHASE REMOVAL, which is just one example, and in other implementations, the flag value may be set to any other value indicative of the second current profile 320. Using the configuration from the second current profile 320 includes applying current to the solenoid injector 30 as specified by the second current profile 320, as shown at 430.

For example, the first current profile 310 specifies applying different current pulses to the solenoid injector 30 compared to the second current profile 320 at energizing time values below the predetermined energizing time threshold value 350. For example, the shapes of the current pulses applied are different, as illustrated by the graphs 305A-D in FIG. 3.

In one or more examples, the controller 40 skips a minimum hold phase when applying the current to the solenoid 30 when the shape flag is set to MIN HOLD-PHASE REMOVAL. In case the flag is set to NO CHANGE, the current applied includes the minimum hold phase.

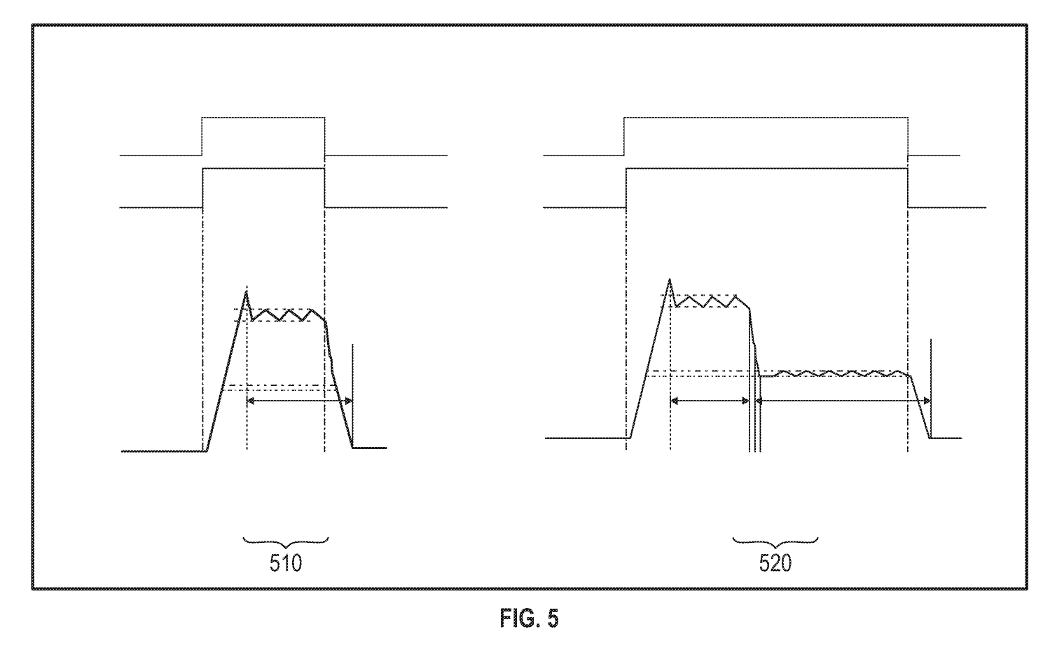

FIG. 5 illustrates a comparison between shapes of current pulses applied below and above the predetermined energizing time threshold value 350 according to one or more embodiments. A plot 510 illustrates a shape of current applied when the energizing time is below the predetermined energizing time threshold value 350, and a plot 520 illustrates a shape of current applied when the energizing time is above (or equal to) the predetermined energizing time threshold value 350. As can be seen in the plot 510, the pulse that is applied when the flag is MIN HOLD-PHASE REMOVAL does not include the minimum hold phase that is present in the plot 520 of the pulse applied when the flag is NO CHANGE.

By skipping (or bypassing) the minimum hold phase, the current applied to the solenoid 30 is not maintained at a predetermined minimum hold value for a predetermined hold duration of the minimum hold phase. Thus, in the two cases, the peak current value applied is substantially identical, however below the predetermined energizing time threshold 350, a shorter pulse is applied compared to the pulse applied above the predetermined energizing time threshold 350. The pulse in the former case is shorter by at least the minimum hold phase duration.

Thus, as depicted in FIG. 5, in case the energizing time is below the predetermined energizing time threshold value 350, the short pulse 510 is applied without the minimum hold phase, such that the Energizing time <PEAK_PERIOD+MIN_HOLD PERIOD. Further, in case the energizing time is above the threshold value 350, the long pulse 520 is applied with the hold phase, such that Energizing time >PEAK_PERIOD+MIN_HOLD.

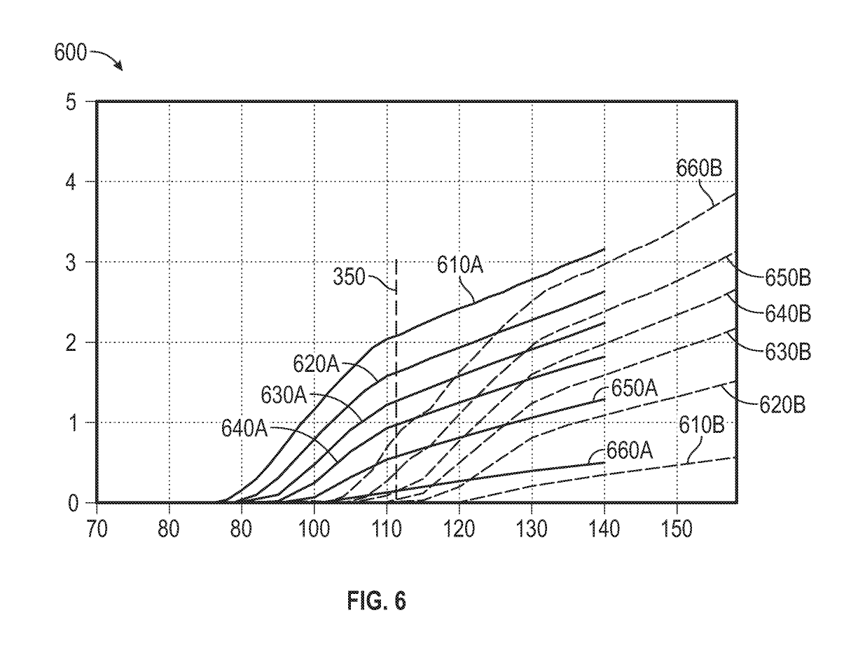

The technical solutions described herein facilitate switching the current profiles at runtime for a range of different pressure values, such as 35-250 MPa at the same predetermined energizing time threshold value. In one or more examples, for different predetermined pressure values, the current profile used is different. FIG. 6 depicts an example graph 600 that depicts current profiles 610A-B, 620A-B, 630A-B, 640A-B, 650A-B, and 660A-B for fuel pressure values 35, 80, 120, 160, 200, and 250 MPa respectively. It should be noted that the depicted graph 600 is one example implementation, and that in other examples, the resulting graph 600 may be different. For example, in other examples number of current profiles may be different, fewer, or more than those in the above example. Thus, the calibrateable energizing time threshold value 350 can be used for different pressure values, where the injection pulse current applied to the solenoid 30 is selected according to the pressure value and the shape flag.

The technical solutions described herein facilitate improved linearity of injector fuel flow characteristic curve in small quantity area with, consequently, higher accuracy of fuel injected quantity for closed loop correction function. Further, the technical solutions facilitate using existing injector current profile definition at higher energizing times, and switch to another fuel flow characterization in small quantity area (for example, below 3 mm̂3/stroke) based on the energizing time requested. The technical solutions address the technical challenges by switching the injector current profile waveforms to be used at runtime, where based on a comparison with a calibrateable energizing time threshold the current profile waveform is dynamically changed. The technical solutions further facilitate injecting shorter injection pulse within injection pattern usage to optimize noise generation and fuel consumption.

The technical solutions described herein facilitate generating a set-point signal, which models a desired electrical current profile flowing through a fuel injector solenoid, the desired electrical current profile being calibrated based on the energizing time threshold. The technical solutions further include regulating the current flowing through the solenoid such that the current flowing through the valve solenoid matches as closely as possible the set point signal. The step response of the solenoid current is determined by the applied voltage and the inductance of the solenoid.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A fuel injector system comprising:
a solenoid injector; and
a controller configured to:
receive a request for energizing the solenoid for an energizing time;
in response to the requested energizing time exceeding a predetermined threshold, hold an electrical current applied to the solenoid injector at a predetermined minimum holding value for a holding phase; and
in response to the requested energizing time being less than the predetermined threshold, apply a predetermined peak-current value to the solenoid injector.

2. The fuel injector system of claim 1, wherein in response to the requested energizing time exceeding the predetermined threshold the controller is further configured to apply to the solenoid injector the electrical current at the predetermined peak-current value prior to the holding phase.

3. The fuel injector system of claim 1, wherein the holding phase has a predetermined duration.

4. The fuel injector system of claim 1, wherein in response to the requested energizing time being less than the predetermined threshold, the controller skips the holding phase.

5. The fuel injector system of claim 1, wherein the solenoid injector is configured to inject an amount of fuel corresponding to the electrical current by opening a fuel injection value based on the electrical current.

6. The fuel injector system of claim 1, wherein the controller is further configured to: in response to the requested energizing time being less than the predetermined threshold, set a current shape flag to a first value that is indicative of using a first current pulse according to a first current profile.

7. The fuel injector system of claim 6, wherein the controller is further configured to: in response to the requested energizing time exceeding the predetermined threshold, set the current shape flag to a second value that is indicative of using a second current pulse according to a second current profile.

8. A computer-implemented method for controlling fuel injection, the method comprising:
receiving a requested energizing time for a fuel injector solenoid;
in response to the requested energizing time exceeding a predetermined threshold, holding an electrical current applied to the fuel injector solenoid at a predetermined minimum holding value for a holding phase; and
in response to the requested energizing time being less than the predetermined threshold, applying a predetermined peak-current value to the fuel injector solenoid.

9. The computer-implemented method of claim 8, further comprising, in response to the requested energizing time exceeding the predetermined threshold, applying to the fuel injector solenoid the electrical current at the predetermined peak-current value prior to the holding phase.

10. The computer-implemented method of claim 8, wherein the holding phase has a predetermined duration.

11. The computer-implemented method of claim 8, further comprising, in response to the requested energizing time being less than the predetermined threshold, skipping the holding phase.

12. The computer-implemented method of claim 8, further comprising injecting an amount of fuel corresponding to the electrical current by the fuel injector solenoid opening a fuel injection valve based on the electrical current.

13. The computer-implemented method of claim 8, further comprising in response to the requested energizing time being less than the predetermined threshold, setting a current shape flag to a first value that is indicative of using a first current pulse according to a first current profile.

14. The computer-implemented method of claim 9, further comprising in response to the requested energizing time exceeding the predetermined threshold, setting the current shape flag to a second value that is indicative of using a second current pulse according to a second current profile.

15. A computer program product comprising a non-transitory computer readable storage medium having computer executable instructions stored thereon, the computer executable instructions when executed by a processing circuit, cause the processing circuit to:
receive a requested energizing time for a fuel injector solenoid;
in response to the requested energizing time exceeding a predetermined threshold, hold an electrical current applied to the fuel injector solenoid at a predetermined minimum holding value for a holding phase; and
in response to the requested energizing time being less than the predetermined threshold, apply a predetermined peak-current value to the fuel injector solenoid.

16. The computer program product of claim 15, the computer executable instructions further causing the processing circuit to, in response to the requested energizing time exceeding the predetermined threshold, apply to the fuel injector solenoid the electrical current at the predetermined peak-current value prior to the holding phase.

17. The computer program product of claim 15, wherein the holding phase has a predetermined duration.

18. The computer program product of claim 15, the computer executable instructions further causing the processing circuit to, in response to the requested energizing time being less than the predetermined threshold, skip the holding phase.

19. The computer program product of claim 15, the computer executable instructions further causing the processing circuit to, inject an amount of fuel corresponding to the electrical current by the fuel injector solenoid opening a fuel injection valve based on the electrical current.

20. The computer program product of claim 15, the computer executable instructions further causing the processing circuit to:
in response to the requested energizing time being less than the predetermined threshold, set a current shape flag to a first value that is indicative of using a first current pulse according to a first current profile; and
in response to the requested energizing time exceeding the predetermined threshold, set the current shape flag to a second value that is indicative of using a second current pulse according to a second current profile.
